(19) United States
(12) Patent Application Publication
(10) Pub. No.: US 2026/0355686 A1
(43) Pub. Date: Nov. 12, 2026

(54) DIRECT CARBON CAPTURE

(71) Applicant: Richard James Hunwick, Sydney NSW (AU)

(72) Inventor: Richard James Hunwick, Sydney NSW (AU)

(21) Appl. No.: 19/126,436

(22) PCT Filed: Nov. 15, 2023
(86) PCT No.: PCT/AU2023/051160

§ 371 Date: May 1, 2025

(30) Foreign Application Priority Data
Nov. 15, 2022 (AU) 2022903433

(51) Int. Cl. B01D 53/62; B01D 53/73; C01C 1/02; F03D 1/04; F03D 1/06; F03D 9/25; F03D 9/37

(52) U.S. Cl. CPC B01D 53/62; B01D 53/73; C01C 1/026; F03D 1/046; F03D 1/0675; F03D 9/25; F03D 9/37; B01D 2251/2062; B01D 2257/504

(57) ABSTRACT

A method and system for sequestration of carbon dioxide from atmospheric air is dexcribed. The method and system enables atmospheric air to pass into an upper end of an elongate hollow tower. An aqueous solution is charged (e.g. via a distributor) so as to mix with the atmospheric air within and adjacent to the tower upper end in a manner such that the air is cooled by evaporative cooling. As a result, the mixture passes downwards as a stream through the hollow tower. The aqueous solution includes a reagent added thereto that reacts with the carbon dioxide to form a compound in the solution to thereby sequester the carbon dioxide from the atmospheric air. The method and system also includes generating electricity (e.g. in an apparatus such as an air turbine) from the downwards stream that is passing through the hollow tower.

### TECHNICAL FIELD

A process and system are disclosed for capturing carbon dioxide from the atmosphere using an aqueous solution comprising a reagent added thereto that reacts with the carbon dioxide. At the same time, the process and system can be used to regenerate the reagent for reuse. Further, the process and system can be used to generate electrical energy (e.g. electricity).

### Background Art

The Intergovernmental Panel on Climate Change (IPCC) in its recently published Sixth Assessment Report has more pointedly impressed the need to keep global warming to just 1.5 °C above its pre-industrial levels. To meet such goals, efforts to minimise carbon dioxide emissions at their sources must be joined by efforts to remove the gas from the broader atmosphere and store it permanently.

WO 2021/081605 discloses a method and a system for sequestering vast quantities of carbon dioxide from the atmosphere. This is achieved using an elongate hollow tower in which an aqueous solution comprising ammonia is charged. As the aqueous solution comprising ammonia is charged into the tower, the ammonia reacts with carbon dioxide to form ammonium bicarbonate. At the same time, a downdraft through the tower is generated, which can be used to generate electricity. The ammonium bicarbonate can be reacted with a suitable metal silicate, to thereby produce a metal carbonate and silica, releasing ammonia.

The inventor has noted that several aspects of the method and system of WO 2021/081605 require further development to provide a whole solution.

The above references to the background art do not constitute an admission that such art forms a part of the common and/or general knowledge of a person of ordinary skill in the art. The above references are also not intended to limit the application of the method and system as disclosed herein.

### SUMMARY OF THE DISCLOSURE

Disclosed herein in a first aspect is a process for recovering ammonia. The process may be used to recover ammonia from an ammonium bicarbonate solution, such as may be produced by scrubbing a gas stream containing carbon dioxide with an aqueous solution comprising ammonia. The gas stream may, for example, comprise atmospheric air. The process of the first aspect may also be used to recover ammonia from the ammonium bicarbonate solution produced in the method and system of WO 2021/081605.

The process can comprise mixing the solution comprising ammonium bicarbonate with a metal silicate to form an ammoniated slurry.

The process can also comprise subjecting the ammoniated slurry to reaction conditions by which the ammonium bicarbonate may react with the metal silicate to form a metal carbonate and silica slurry, and whereby ammonia may be released.

In accordance with the process as disclosed herein, the ammoniated slurry can be overlayed with an aqueous layer to create a top aqueous layer and a bottom ammoniated slurry layer. The ammonia that is released from the bottom ammoniated slurry layer can pass into the top layer such that an aqueous solution comprising ammonia can be produced.

The process of the first aspect may be employed to recover ammonia from an ammonium bicarbonate solution by producing an aqueous solution comprising ammonia. By recovering the ammonia in this form, the aqueous solution comprising ammonia may be used for scrubbing the gas stream containing carbon dioxide (e.g. atmospheric air). In this way, the process of the first aspect can provide for carbon capture in which ammonia is continuously recycled and recovered in a “closed-loop”. This can also minimise the requirement for fresh ammonia production. Further, the process may allow the scrubbed carbon dioxide to be converted to a more stable form for long term storage, or to a form which may be used in a construction material.

In some embodiments, the reaction conditions to which the ammoniated slurry is subjected may comprise elevated temperatures. The reaction conditions may also comprise elevated pressures. For example, the elevated temperature may be below the boiling point of water at the elevated pressure. Such reaction conditions may promote the reaction of the ammonium bicarbonate with the metal silicate.

For example, the ammoniated slurry may be subjected to an elevated temperature of about 150 °C. The ammoniated slurry may also be subjected to an elevated pressure of about 4.0 Bar gauge.

In some embodiments, the elevated pressure of the ammoniated slurry may be generated by overlaying the ammoniated slurry with the top aqueous layer. Further, in some embodiments, the depth of the top aqueous layer may be varied to control the elevated pressure of the ammoniated slurry.

In some embodiments, during the reaction between the ammonium bicarbonate and metal silicate, the top aqueous layer may be maintained separated from the bottom slurry layer. Further, whilst the aqueous solution remains separated, ammonia may be able to pass from the bottom ammoniated slurry layer into the top aqueous layer. This may allow the recovery of ammonia directly into an aqueous solution, thereby producing an aqueous solution comprising ammonia, such as can be used for scrubbing carbon dioxide. For example, in some embodiments, the separation may be maintained by a baffle—e.g. a floating baffle.

In some embodiments, as part of the reaction conditions, the ammoniated slurry may be subject to agitation. In some embodiments, as part of the reaction conditions, the ammoniated slurry may be subjected to aeration. For example, the aeration may be provided by injecting air bubbles into the ammoniated slurry. Agitation and/or aeration can further promote the reaction of the ammonium bicarbonate with the metal silicate.

In some embodiments, as part of the reaction conditions, the ammoniated slurry may be passed through a series of reactors. In some embodiments, as part of the reaction conditions, the aqueous solution may be flowed in a counter-current direction to the ammoniated slurry. Again, such reaction conditions can further promote the reaction of the ammonium bicarbonate with the metal silicate.

In some embodiments, the aqueous solution may comprise seawater. Advantageously, seawater has a higher density than fresh water, and often may be more readily accessible at a given location where the process is implemented.

In some embodiments, the aqueous solution may have a temperature of about 25 °C (e.g. approximating ambient temperature).

In some embodiments, the reaction of the ammonium bicarbonate with the metal silicate and the production of the aqueous solution comprising ammonia, may be conducted in one or more sealed reactors. Such sealed reactor(s) can serve to prevent ammonia from escaping into the atmosphere.

In some embodiments, the metal carbonate and silica slurry may be passed through to a cooling stage. In the cooling stage, residual ammonia that may be contained in the slurry may be recovered. For example, the residual ammonia can be released as the slurry is cooled, and thus may be captured by the aqueous solution comprising ammonia.

In some embodiments, the metal silicate may comprise an ultramafic mineral. Thus, the reaction between the ammonium bicarbonate and the metal silicate may produce magnesium carbonate and silica. For example, a seed slurry of crystalline magnesium carbonate may be added to the ammoniated slurry. The seed slurry may facilitate growth of magnesium carbonate crystals during the reaction of the ammonium bicarbonate and the metal silicate.

In some embodiments, the magnesium carbonate and the silica may be recovered. The magnesium carbonate and silica may be recovered for use in a construction cement.

In some embodiments, the silica may be separated from the magnesium carbonate. The separated silica may be used as a raw material to produce glass fibre. Further, the glass fibre may be added to the construction cement to provide reinforcing thereto.

Also disclosed herein in a second aspect is a process for producing a construction material. The process may be used to produce a construction material from a solution comprising ammonium carbonate.

The process can comprise providing a solution comprising ammonium bicarbonate. The solution comprising ammonium bicarbonate may be produced by scrubbing a gas stream that comprises carbon dioxide (e.g. atmospheric air) with an aqueous solution comprising ammonia. The carbon dioxide may react with the ammonia in solution to produce the solution comprising ammonium bicarbonate. Other sources for the gas stream that comprises carbon dioxide include flue gases from power stations and cement manufacturing. The process of the second aspect may also use the ammonium bicarbonate solution produced in the method and system of WO 2021/081605.

The process can also comprise mixing the solution comprising ammonium bicarbonate with a magnesium silicate to form an ammoniated slurry.

The process can further comprise subjecting the ammoniated slurry to reaction conditions by which the ammonium bicarbonate may react with the magnesium silicate to form a slurry comprising magnesium carbonate and silica, and to form ammonia. Further, the magnesium carbonate and silica slurry may be separated from the slurry and used to produce the construction material. The magnesium carbonate can be used to form a type of cement.

The ammonia that is formed under the reaction conditions may be recovered for reuse in scrubbing the gas stream. For example, the ammonia may be recovered by the process as set forth in the first aspect.

The process of the second aspect can provide an end-use for the magnesium carbonate and silica that is produced when an (abundant) magnesium silicate is reacted with an ammonium bicarbonate solution to recover the ammonia therefrom. The silica may be separated to form a product separate from the magnesium carbonate construction material.

The process of the second aspect can provide an alternative to discarding the magnesium carbonate and silica (such as by discharging them into an adjacent ocean, as is suggested in WO 2021/081605). Furthermore, the construction material that is produced from the magnesium carbonate and (optionally) silica may be used in the construction of apparatus (e.g. infrastructure apparatus). Such apparatus may, in turn, be used for scrubbing a gas stream (e.g. atmospheric air) to remove carbon dioxide therefrom. The construction material may also be used to construct roads, ports and other infrastructure associated with the scrubbing apparatus.

In some embodiments, the process of the second aspect may comprise removal (e.g. decantation) of excess water from the magnesium carbonate and silica slurry to thereby form a component of the construction material.

In some other embodiments, the magnesium carbonate and silica slurry may be passed to a separation stage in which a silica slurry may be separated from a magnesium carbonate product which may thereby form a component of the construction material.

In some embodiments, the magnesium carbonate and silica may be mixed together with magnesium oxide and carbonated water which may then form the construction material. In this case, no separation of the silica is performed.

In some other embodiments, the silica separation stage may comprise a flotation stage in which the silica may be floated off to form the silica slurry. For example, flotation may be performed to separate the silica slurry from a magnesium carbonate product underflow.

In some embodiments, the silica slurry from the flotation stage may be further subjected to heating to produce a silica melt. Further, the silica melt may be passed to a spinning stage in which a silica glass-fibre product may be produced. The silica glass-fibre product may, for example, be added back into to the construction material (e.g. to act as a reinforcing material therefor).

In some embodiments, the magnesium carbonate product from the separation stage may be further treated to produce a mixed magnesium carbonate, magnesium oxide, and magnesium hydroxide product. Said product may form a component of the construction material. For example, a cement comprising the magnesium carbonate product can be enhanced by the addition/formation of magnesium oxide and magnesium hydroxide thereto.

Also disclosed herein, in a third aspect, is a deployable structure. The deployable structure may be configured and designs such that it is suitable for scrubbing carbon dioxide from a gas stream (e.g. atmospheric air). As set forth below, the deployable structure of the third aspect may also be used with the method and system of WO 2021/081605.

The deployable structure may comprise a collapsible wall wherein the collapsible wall may be deployable between a collapsed orientation and an erected orientation.

The deployable structure may also comprise a balloon structure. The balloon structure may be filled with a gas less dense than air or a mixture of gases less dense than air. Further, the balloon structure may be connectable with respect to the collapsible wall and may be configured to cause the collapsible wall to move from the collapsed orientation to the erected orientation as the balloon structure is deployed from a grounded position to an elevated position.

The deployable structure may further comprise a guide structure configured to guide the balloon structure as it moves from the grounded position to the elevated position and causes the collapsible wall to move from the collapsed orientation to the erected orientation.

The deployable structure of the third aspect may be suitable for deployment anywhere in the world. However, the deployable structure may be of particular use in regions which experience harsh conditions, such as tropical cyclones, sand and dust storms, etc. Typically, structures built in such regions must have significant engineering and reinforcement to ensure they can withstand storms reaching category 5 strengths. On the other hand, the deployable structure of the third aspect can be collapsed to a grounded position as a storm is approaching. The deployable structure of the third aspect can also be collapsed for maintenance, etc. Examples of regions that may benefit from the deployable structure comprise the Pilbara, Arabian Sea, and southern Baja California. These regions are also particularly well suited to the placement of structures for sequestering carbon dioxide from the atmosphere and for generating electricity, which may be a primary use of the deployable structure of the third aspect.

As set forth in WO 2021/081605, a tower for sequestering carbon dioxide from the atmosphere is required to be a massive structure and is typically located for best effect in areas prone to cyclonic, etc. activity. The tower set forth in WO 2021/081605 is required to be built to withstand such cyclonic, etc. activity. The deployable structure of the third aspect can be considerably simplified and can replace the massive tower construction of WO 2021/081605 and can be stowed during bad weather or maintenance.

In some embodiments, the collapsible wall may be configured such that, when in the erected orientation, it may divide an internal space of the structure from an external space by which an elongate hollow enclosure may be defined. Further, the elongate hollow enclosure may be configured so as to allow the gas stream (e.g. atmospheric air) to pass into an open upper end of the elongate hollow enclosure.

For example, the collapsible wall in the erected orientation may be generally hyperbolic when viewed in a front elevation. In the erected orientation: a smallest diameter of the collapsible wall may occur at an intermediate location of the collapsible wall; a top section of the collapsible wall may have a larger diameter than the smallest diameter; and a bottom section of the collapsible wall may have a larger diameter than the smallest diameter. Thus, when erected, the deployable structure can be configured with an enlarged open mouth at its in-use upper end. This can help to promote/facilitate a flow of the gas stream therein.

In some embodiments, the collapsible wall may comprise a flexible material. Such a material can allow the collapsible wall to be deployed between the collapsed orientation and the erected orientation. The material may, for example, comprise a synthetic canvas, a reinforced woven polymer, etc.

In some embodiments, the balloon structure may have a circular cross-section and may be circular around its periphery. Further, the balloon structure may be connected to an in-use upper edge of the collapsible wall around the periphery of the balloon structure. The balloon structure may be fabricated from a similar/same material as the collapsible wall. The balloon structure may be formed as a folded-back-over continuation of the material of the collapsible wall.

In some embodiments, the guide structure may comprise a guide column that is connected to the balloon structure. For example, the guide column may be connected to the balloon structure through a plurality of guide wires. The plurality of guide wires may be configured such that a first end of each of the plurality of guide wires is connected to the balloon structure (e.g. at discrete points around a periphery of the balloon structure).

The plurality of guide wires may be further configured such that each of the plurality of guide wires extends through the guide column to a second remote end thereof. The second end of each of the plurality of guide wires may be connected to a drive spool. The drive spool may be located at a base in use of the guide column. Each drive spool may allow its respective guide wire to be reeled out or in as the balloon structure moves between the grounded position to the elevated position.

In some embodiments, the guide structure may be centrally located within the balloon structure and the collapsible wall. Thus, the guide wires may radiate out from an upper end of the guide column to be connected to the balloon structure.

In some embodiments, the balloon structure may be filled with hydrogen. Further, the balloon may be filled with hydrogen at an overpressure not exceeding 20 kPa. Hydrogen gas can be readily procured and/or manufactured on site (e.g. by electrolysing seawater). Hydrogen gas is considerably less dense than air and so facilitates lifting of the balloon structure from the grounded position to the elevated position.

In some embodiments, the deployable structure may further comprise one or more pipes. These pipes may be located at the guide structure and may be configured and arranged such that an aqueous solution may be pumped through the pipes to a top (upper end) of the guide structure. The deployable structure may further comprise a distributor (e.g. spray headers) connected to the one or more pipes and arranged to charge into the deployable structure the aqueous solution. The distributor may be mounted with respect to a top (upper end) of the guide structure and may extend to the balloon structure when located at the elevated position. The distributor (e.g. spray headers) can distribute the aqueous solution into the gas located at an open upper end of the deployable structure. An example of such a distributor is set forth in WO 2021/081605, the relevant contents of which are incorporated herein by way of cross-reference. The aqueous solution may be charged from the distributor (e.g. as droplets/mist/atomised spray) into the gas at the open upper end, thereby mixing with the gas and cooling it by evaporative cooling. As a result of such evaporative cooling, the mixture will tend to flow downwards as a gas stream through the deployable structure.

In some embodiments, the guide structure may be centrally located within the deployable structure in-use. Further, the distributor may comprise a series of spray headers. The spray headers may have a first end connected to the guide structure and may have a second end connected to the balloon structure.

In some embodiments, the series of spray headers may be configured with the guide structure and the balloon such as to allow the spray headers to be deployed between a non-use position and an in-use position as the balloon structure moves from the grounded position and into the elevated position.

In some embodiments, the deployable structure may comprise electricity generation apparatus that is configured to generate electricity from the downwards passing stream. The electricity generation apparatus may be located at an in-use lower end of the deployable structure. Further, the deployable structure may be sized and geographically located such that the downwards stream possesses significant kinetic energy to generate electricity (e.g. such as by passing through one or more turbines).

The electricity generation apparatus may form an integral part of the deployable structure. In this regard, it may generate sufficient electricity to power all components of the structure, including nearby related infrastructure. The electricity generation apparatus may even generate surplus electricity (e.g. for export to a mains grid). The electricity generation apparatus may be designed to be reliable and efficient, with minimal maintenance required.

In some embodiments, the deployable structure may comprise an apparatus arranged to produce an aqueous solution comprising a reagent therein that is able to react with carbon dioxide in the gas stream. The reagent may be ammonia. When the aqueous solution comprising the reagent is charged by the distributor into the deployable structure, the reaction of the reagent and carbon dioxide can take place as the stream passes downwards, thereby progressively forming a compound in the aqueous solution.

Also disclosed herein, in a fourth aspect, is a system for electrical energy generation in an elongate hollow tower. The elongate hollow tower may be configured such that atmospheric air is able to pass downwards through the tower from an upper end towards a lower end. For example, the atmospheric air may be caused to pass downwards through the tower (e.g. by spraying a liquid such as water/seawater into the air located adjacent to an open upper end of the elongate hollow tower). The system of the fourth aspect may also be used in the method and system of WO 2021/081605.

The system of the fourth aspect may comprise a distributor arranged to charge into the tower an aqueous solution. The aqueous solution can be charged so as to mix with the atmospheric air in a manner such that the atmospheric air is cooled by evaporative cooling. As a result of such evaporative cooling, the mixture can pass downwards as a stream through the tower.

The system may further comprise a turbine (i.e. for electrical energy generation). In accordance with the disclosure, in a unique configuration, the turbine can be configured such that its rotational axis can be aligned with an elongate axis of the tower (e.g. such that both are vertical). The turbine may comprise a series of turbine blades arranged on a rotor that rotates on the turbine rotational axis. The turbine may further be arranged in use such that the downwards stream passes through the turbine and acts on the turbine blades. Said action on the turbine blades can cause the rotor to rotate and generate electrical energy.

The system of the fourth aspect can provide one (very) large turbine, rather than a series of adjacent, horizontal axis turbines (e.g. such as set forth in WO 2021/081605). The system can be ‘switched’ into an “off” mode, such as when the hollow tower is not in-use. The system can also be optimised based on the current wind conditions, ensuring maximum electrical generation.

The turbine of the fourth aspect may generate sufficient electricity to power the system itself as well as nearby infrastructure. The turbine may even generate surplus electricity (e.g. for export to a mains grid). A single (very) large turbine can be reliable, efficient, and require minimal maintenance.

In some embodiments, the rotor may surround a base of the tower such that the downwards stream can pass down through the tower and may then flow laterally out, passing through (i.e. between and over) the turbine blades.

In some embodiments, the system of the fourth aspect may further comprise a separator arranged at a lower end of the tower. The separator may be located to separate the aqueous solution from the downwards stream, thereby producing an airstream that is substantially droplet/mist-free. The separator may be located to separate the aqueous solution from the airstream before it flows to the turbine.

In some embodiments, the turbine blades may have a sail profile such that, as the downwards stream flows onto a face of the blade, the blade causes the rotor to rotate. The turbine blades may be adjustable between an open position in which the downwards stream is able to cause the blade to act on the rotor, and a closed position in which the turbine is closed to a flow of the downwards stream therethrough. This can allow the system to be configured between an in-use configuration and an ‘off’ configuration. For example, if the tower requires maintenance the system can be turned to the off configuration. Likewise, if there is insufficient energy in the downwards stream to generate electrical energy, the system can be turned to the off configuration.

In some embodiments, the rotor may further comprise an upper runner to which an in-use upper end of each of the turbine blades may be attached and a lower runner to which an in-use lower end of each of the turbine blades may be attached. Each of the turbine blades may be attached to the upper and lower runners via an axle to which the blade can be pivotally connected. Further, permanent magnets (i.e. for electricity generation) may be affixed to both the upper runner and the lower runner.

In some embodiments, the turbine may further comprise a stator. The stator may comprise a top frame in which the upper runner may be received and a bottom frame in which the lower runner may be received. The stator may comprise electrical windings (e.g. coils) affixed thereto. An electrical current may be induced in the electrical windings as the downwards stream acts on the turbine blades, causing the rotor to rotate with respect to the stator which remains stationary, with the moving permanent magnets causing an electrical current to be generated in the electrical windings.

In some embodiments, the upper runner may be received in the top frame and the lower runner may be received in the bottom frame in a manner such that the friction between the runners and the frames may be minimised when the rotor is rotating. For example, friction may be minimised between the lower runner and bottom frame by magnetic levitation (e.g. magnetic repulsion between the upper runner and the top frame and between the lower runner and the bottom frame).

In some embodiments, the turbine blades may be equally spaced around the rotor. Further, a pitch of each turbine blade may be configured to be increased or decreased. This can allow the pitch of each turbine blade to be adjusted based on current wind conditions to optimise electricity generation. This adjustment may be made as part of a system control procedure. In some embodiments, the system may further be configured so as to allow the number of turbine blades to be increased or decreased (e.g. blades may be added in or removed as required).

In some embodiments, the system of the fourth aspect may further comprise an apparatus arranged to produce an aqueous solution comprising a reagent therein that is able to react with carbon dioxide in the atmospheric air (e.g. the reagent may be ammonia). When the aqueous solution comprising the reagent is charged by the distributor into the tower, the reaction of the reagent and carbon dioxide can take place as the stream passes downwards, thereby progressively forming a compound in the aqueous solution. In such case, the atmospheric air can be ‘scrubbed’ of the carbon dioxide therein.

Also disclosed herein, in a fifth aspect, is a system for power generation using an electric field in an elongate hollow tower. The system may be simultaneously used for sequestering carbon dioxide from a gas stream (e.g. atmospheric air). The elongate hollow tower can be configured to allow the gas stream to pass downwards through the tower from an upper end towards a lower end. The system of the fifth aspect may also be used in the method and system of WO 2021/081605.

The system can comprise a distributor arranged to charge into the tower an aqueous solution. The distributor may charge the aqueous solution into the tower in the form of droplets (which may be atomised/mist-like). The droplets can mix with the gas to evaporatively cool the gas. As a result of such evaporative cooling, a downward draft (i.e. gas stream) is produced which can cause the mixture to pass downwards as a stream through the tower.

The system can also comprise electrical charging apparatus arranged at the upper end of the tower but positioned below the distributor. The electrical charging apparatus may be configured to provide an electrical charge to the droplets, thereby producing charged droplets that can pass downwards through the tower due to the downdraft. The electrical charging apparatus may be electrically isolated from earth.

The system can further comprise a series of earth conductors arranged at the lower end of the tower. The charged droplets may be collected by the series of earth conductors and charge may be transferred from the droplets to the conductors, thereby producing a charge-neutral aqueous solution. The charge may flow back to the electrical charging apparatus.

In some embodiments of the system of the fifth aspect, the charge collected by the series of earth conductors may flow through a load before flowing back to the electrical charging apparatus. The load may comprise a pumping station by which the aqueous solution is pumped to the top of the tower. The load may also comprise other electrical components associated with the system.

An advantage of the system of the fifth aspect is that it is able to generate electricity without as many moving mechanical parts as, for example, would be present in a traditional air-or wind-driven wind turbine. This has the capacity to significantly reduce capital and operating costs of the system.

In some embodiments of the system of the fifth aspect, an inside wall of the tower may be coated with a water repellent coating. This can ensure that the charged droplets do not discharge to the wall of the tower.

In some embodiments of the system of the fifth aspect, the electrical charging apparatus may comprise a grid of electrically conductive parts. For example, the electrically conductive parts may comprise conductive rods, wires, sharp edges and points. Such a grid may be arranged adjacent to (i.e. to be positioned below) the distributor.

In some embodiments of the system of the fifth aspect, the electrical charging apparatus may be configured to provide the electrical charge in the form of a coronal discharge.

In some embodiments, the system of the fifth aspect may further comprise an apparatus arranged to produce an aqueous solution comprising a reagent therein that is able to react with carbon dioxide in the gas stream (e.g. the reagent may be ammonia). When the aqueous solution comprising the reagent is charged by the distributor into the tower, the reaction of the reagent and carbon dioxide can take place as the stream passes downwards, thereby progressively forming a compound in the aqueous solution. When the gas stream is atmospheric air, the reagent may scrub carbon dioxide therefrom.

Also disclosed herein, in a sixth aspect, is the deployable structure as set forth in the third aspect, in which the electricity generation apparatus comprises one, or the other, or a combination thereof, of the systems as disclosed in the fourth aspect and the fifth aspect.

### BRIEF DESCRIPTION OF THE DRAWINGS

Embodiments of a process and systems as set forth in the Summary will now be described, by way of example only, with reference to the accompanying drawings, in which:

FIG. 1 is a schematic flow diagram of a process for carbon dioxide sequestration directly from the atmosphere using ammoniated seawater.

FIG. 2 is a schematic diagram of an energy tower complex used to generate a massive flux of air through the tower and bring this air into contact with ammoniated seawater to capture carbon dioxide directly contained in the air, with the energy tower forming the initial stages of the carbon dioxide sequestration process.

FIG. 3 is a plan view schematic diagram of the apparatus required for the direct air capture of carbon dioxide from the atmosphere using ammoniated brine, and the permanent storage of the carbon dioxide by converting it to mineral carbonates.

FIG. 4 is a schematic diagram of a reactor used firstly for converting carbon dioxide captured from the atmosphere, using an ammoniated brine, to mineral carbonates using ultramafic rocks, and for recovering ammonia and transferring this to form fresh ammoniated brine for re-use in the energy tower complex.

FIG. 5 is a schematic diagram of a deployable structure configured in an in-use orientation.

FIG. 6 is a schematic diagram of a deployable structure configured in an off orientation.

FIG. 7 is a plan view schematic diagram of a turbine for use in an energy tower (e.g. the deployable structure) in which electrical energy is generated through linear induction.

FIG. 8 is a schematic diagram of a section of a system for use in an energy tower (e.g. the deployable structure) to generate electricity using an electric field.

FIG. 9 is a similar plan view schematic diagram to FIG. 3, but illustrating an arrangement of the guide column, guide wires and spray headers located at an upper end of the energy tower in use.

### DETAILED DESCRIPTION OF SPECIFIC EMBODIMENTS

In the following detailed description, reference is made to accompanying drawings which form a part of the detailed description. The illustrative embodiments described in the detailed description, depicted in the drawings and defined in the claims, are not intended to be limiting. Other embodiments may be utilised and other changes may be made without departing from the spirit or scope of the subject matter presented. It will be readily understood that the aspects of the present disclosure, as generally described herein and illustrated in the drawings can be arranged, substituted, combined, separated and designed in a wide variety of different configurations, all of which are contemplated in this disclosure.

The following description discloses an embodiment of a process and systems for recovering ammonia from a solution comprising ammonium bicarbonate. From the solution comprising ammonium bicarbonate, ammonia is released and reused to produce an aqueous solution comprising ammonia. The process and systems are designed to form part of a carbon capture and energy generation system.

Carbon dioxide can be scrubbed from a gas stream by means of an aqueous solution comprising a reagent therein such that, when the gas stream and the aqueous solution come into contact (e.g. mix), the reagent reacts with the carbon dioxide thereby forming a compound in solution. The carbon dioxide is therefore captured by the aqueous solution and is thereby removed from the atmosphere so processed.

As taught by WO 2021/081605, ammonia is a particularly advantageous reagent in that it can be regenerated. On contacting the gas stream comprising carbon dioxide (which may be ambient air), the aqueous solution comprising ammonia reacts with the carbon dioxide, thereby forming ammonium bicarbonate in solution. The ammonium bicarbonate solution is recovered and treated with an ultramafic rock, such as peridotite, thereby producing magnesium carbonate and silica and releasing ammonia. The released ammonia is recovered and reused to produce more aqueous solution comprising ammonia. In general, a suitable method and system for capturing carbon dioxide from air using an aqueous solution comprising ammonia in an elongate hollow tower can as set forth in the inventor's method and system as outlined in WO 2021/081605 (the relevant contents of which are incorporated herein by reference). The present disclosure seeks to extend and build upon the disclosure as outlined in WO 2021/081605.

A brief outline of the process by which the carbon dioxide is captured by the aqueous solution will now be given, to provide further context for the process and systems as disclosed herein.

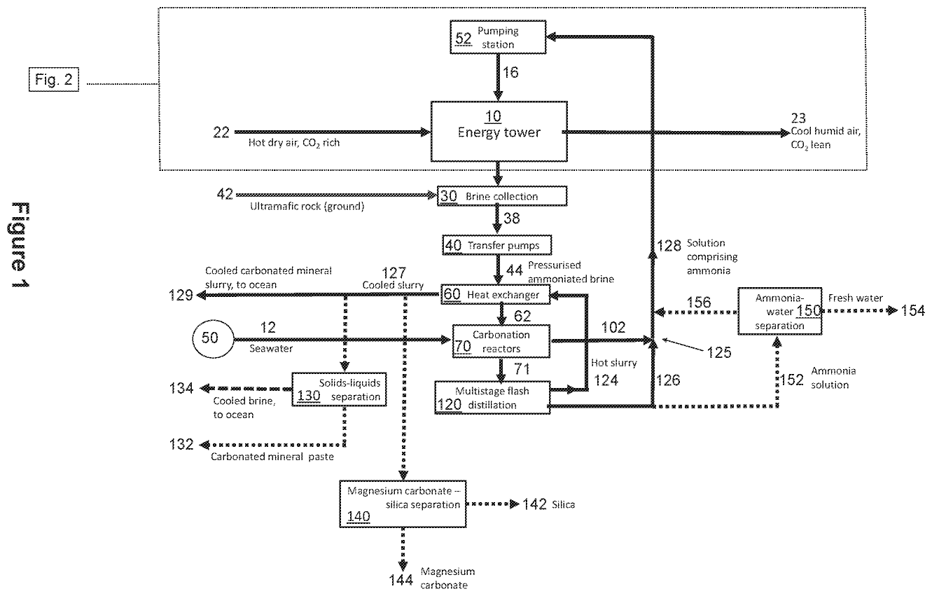

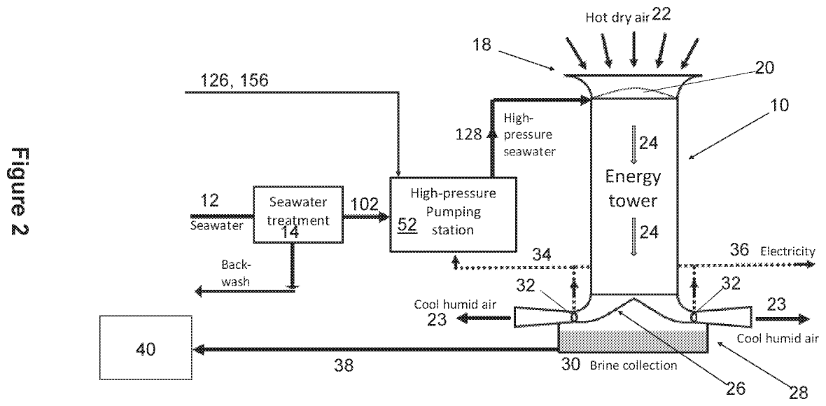

### Overall Process (FIGS. 1 and 2)

FIG. 1 provides a schematic of the overall flowsheet for a carbon capture and storage process using ammonia. FIG. 2 provides a schematic of an elongate (energy) tower suitable for implementing this process.

Suitable sites for the tower tend to comprise coastal desert regions on the western margins of continents between latitudes of 20-30 degrees from the equator-for example-the Pilbara in northwest Australia; the Atacama Desert in Northern Chile/Southern Peru; Baja California in Mexico; Kalahari Desert in Namibia; Western Sahara; the Sultanate of Oman; and other regions around the Arabian Sea. The tower generally has a height of 1,200 m (or at least over 1,000 m) such that the tower projects well above the subtropical inversion layer (a natural artefact of Earth's broad atmospheric circulation, the Hadley cell), for the majority of the year in these locations. The tower in this embodiment has a minimum diameter of approximately 400 m and is typically hyperbolic in shape.

As illustrated in FIGS. 1 and 2, a scrubbing medium: typically, seawater/brine 12 is treated (e.g. screened/filtered) at station 14 (FIG. 2) and is then passed into a seawater holding basin 50 (FIG. 1). The seawater is drawn from basin 50 and is first pumped to carbonation reactors 70. By passing the seawater 12 through the carbonation reactors 70, a seawater solution comprising ammonia 102 is formed. The seawater comprising ammonia 102 may be pumped directly to an energy tower 10, or it may be combined with other solutions comprising ammonia 126, 156 (described below) to produce a solution comprising ammonia 128.

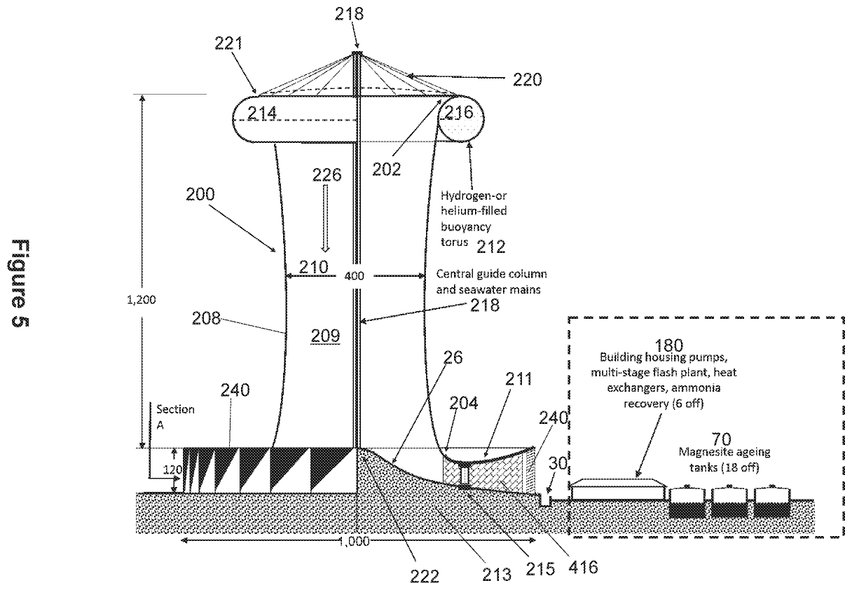

In either case, the seawater/solution comprising ammonia 102/128 is pumped, via a high-pressure pumping station 52, to the upper end 18 of the energy tower 10. Examples of the tower 10 are shown in each of FIGS. 2 and 5, with the tower also able to be embodied as set forth in WO 2021/081605.

The seawater/solution comprising ammonia 102/128 is sprayed 20 into air located within the tower 10, at or towards an open upper end 18 thereof. The seawater/solution is typically sprayed into the air as droplets, mist, etc. via a distributor which comprises a spraying system located in the vicinity of the tower upper end 18.

Initially, at commencement of tower operations, the seawater/brine 12 is dosed with ammonia to serve as the active reagent for extracting carbon dioxide from the air. Once operational, an ammoniated (‘reacted’) brine slurry 38 is collected from the energy tower 10 and is eventually passed through the carbonation reactors 70, in which the ammonia is recovered from the reacted brine collected from the tower. The recovered ammonia can be reused to produce more seawater/solution comprising ammonia 102/128 to be sprayed into the tower 10.

Typically, the air that passes into the open upper end 18 of the energy tower 10 is a hot, dry, CO₂-rich air 22 (FIG. 2), such as can be found in the desert regions of the world. Conversely, a cool CO₂-lean air stream 23 leaves the tower. When the ammonia-containing spray droplets are sprayed within the tower upper end 18 they contact carbon dioxide within the air 22, whereby ammonium bicarbonate starts to form in the droplets, as per the following reaction:

NH₃+H₂O+CO₂↔NH₄⁺+HCO₃⁻ (1)

Typically, some of the water in the seawater/solution comprising ammonia that is charged into the air at the tower upper end 18 evaporates. This evaporation serves to cool and humidify the air (which is typically hot, dry ambient desert air). This makes the air denser, leading to a powerful, reverse-chimney effect inside the tower 10 with potentially high downdraft velocities. When combined with a relatively large tower diameter, this can yield an immense airflow in the energy tower 10.

Thus, the atmospheric air containing carbon dioxide flows as a stream 24 (FIG. 2) down through the energy tower 10 along with the aqueous solution comprising ammonia. The high air flow and resulting turbulence cause the air and aqueous solution to vigorously mix, whereby the carbon dioxide continues to react with the ammonia to form ammonium bicarbonate in solution (as per equation (1)).

Typically, a convex surface 26 is located at the base 28 of the energy tower 10 (FIG. 2). As the highly humidified airflow 24 engages with the convex surface 26, at least some of the aqueous solution will condense/coalesce at the convex surface 26 and will thereby flow down to be collected in a collection launder 30 located at or surrounding the base 28 of the energy tower 10.

As the highly humidified airflow 24 engages with the convex surface 26, the kinetic energy possessed by the airflow is harnessed. Generally, the harvesting systems are two-fold. A first system comprises one or more turbines 32. The second system exploits the properties of charged particles in an electric field. Each of the first and second systems used to convert the kinetic energy to electrical energy are described in more detail below. Whilst WO 2021/081605 also describes a turbine-type electrical energy generation system, an alternative turbine-type electrical energy generation system is described in more detail below.

Mist eliminators are located after the turbine(s) 32 to capture remaining airborne solution from the turbine exhaust and direct it back into the brine collection launder 30. This means that a CO2-scrubbed, substantially moisture-free air stream 23 is able to leave the energy tower 10 and pass into the atmosphere.

A portion of the generated electrical energy 34 is directed to the high-pressure pumping station 52 and is typically sufficient to provide the total energy required to pump the brine to the top 18 of the energy tower 10. Optionally, another portion of the electrical energy is used to power an electrical generation apparatus of the second energy generation system, as set forth below. Electrical energy may also be consumed by other operating equipment and systems associated with the energy tower 10. Any remaining (i.e. surplus) electrical energy 36 (FIG. 2) is fed to the main electricity grid.

The collected ammoniated brine held in collection launder 30 is now ready to be mixed and reacted with a metal silicate of a chemical composition defining it as a type of abundant ultramafic rock 42 located in the vicinity of, or transported to, the energy tower. This reaction enables the ammonia to be recovered from the ammonium bicarbonate for reuse in the energy tower 10 and enables the conversion of the carbon dioxide to more stable and useable forms such as metal carbonates. Reference to the ultramafic rock peridotite as an example metal silicate will mainly be given, noting that other ultramafic rocks can be employed.

After being mixed with the (finely divided) ultramafic rock 42, the ammoniated brine 38 is pumped from the collection launder 30 via a series of transfer pumps 40, which increase the pressure of the ammoniated brine. The pressurised ammoniated brine 44 passes through a heat exchanger 60 in order to preheat the ammoniated brine slurry 62 fed to the carbonation reactors 70. FIG. 1 shows that each heat exchanger 60 receives therethrough a hot ammonia-depleted slurry 124 that is recycled from the multistage flash evaporators of ammonia recovery stage 120.

In the carbonation reactors 70, the pressure of the ammoniated brine slurry is maintained by overlaying the brine slurry with a layer of seawater 12. Under the high temperatures that such pressure allows, the ground ultramafic rock 42 reacts with ammonium bicarbonate in the brine slurry, thereby producing magnesium carbonate and silica, and releasing ammonia. The ammonia is allowed to pass into the seawater to produce seawater comprising ammonia 102.

The brine slurry 71, now primarily magnesium carbonate and silica with some remaining ammonia, is typically passed to an ammonia recovery stage that comprises a multistage flash distillation facility 120. In facility 120, remaining ammonia is distilled off from the slurry via a number of flash evaporators arranged in series. The hot slurry is boiled successively (in stages) under increasingly reduced pressures, whereupon the ammonia contained in the slurry is stripped out by the water vapour that is also produced. This forms a further solution comprising ammonia 126. The solution 126 can be passed to an ammonia-water separation stage 150 (described below) and/or can be combined with the seawater comprising ammonia 102 at a mixing point 125.

The hot (ammonia-depleted) slurry 124 that is produced in the distillation facility 120 is then passed through the heat exchanger 60 to impart its heat to the new incoming pressurised brine slurry 44. The cooled ammonia-depleted slurry 127 can either be passed directly to the ocean 129, and/or to a solids-liquids separation facility 130, and/or to a magnesium carbonate-silica separation facility 140.

In the solids-liquids separation facility 130, the ammonia depleted slurry of magnesium carbonate, along with silica and other insoluble solids, is separated as a stream 132 from a cooled aqueous brine solution 134. The cooled aqueous brine 134 is returned to the ocean. The solids stream 132 is essentially inert, making it suitable for use in industry, for example, as a construction material. The solids stream 132 is also suitable for use as landfill (e.g. for repatriation at the mine site from which the metal silicate was mined), for emplacement in playas on land, or for direct disposal into the ocean.

In the magnesium carbonate—silica separation facility 140, the slurry is passed through one or more flotation cells. In the flotation cells, a silica product 142 is floated to the top and a magnesium carbonate product 144 is collected as an underflow. The two products (142 and 144) are each in a form that can be used by the construction industry. Further, the silica product 142 may optionally be melted in an electric furnace and spun to produce a spun silica fibre. Such a fibre can be used as a reinforcing material in a cement produced from the magnesium carbonate product 144. In this way, a bulk of the materials used in the CO2-scrubbing and energy generation process can be usefully deployed.

In the distillation facility 120, the mixed ammonia-water vapour can be condensed by contacting the vapour with the seawater comprising ammonia 102. This contact can take place in the distillation facility 120 or subsequently. This increases the concentration of ammonia in the seawater solution. As set forth above, the total solution comprising ammonia 128 is pumped by the pumping station 52 to the upper end 18 of the energy tower 10.

Optionally, as set forth above, a proportion (or all) of the mixed ammonia-water solution 126 is passed to an ammonia-water separation stage 150. In this stage 150, the mixed ammonia-water solution 126 is fractionated to yield additional fresh water 154 and a more concentrated ammonia-water solution 156. The more concentrated solution 156 is combined with the seawater comprising ammonia 102 to form the total solution comprising ammonia 128.

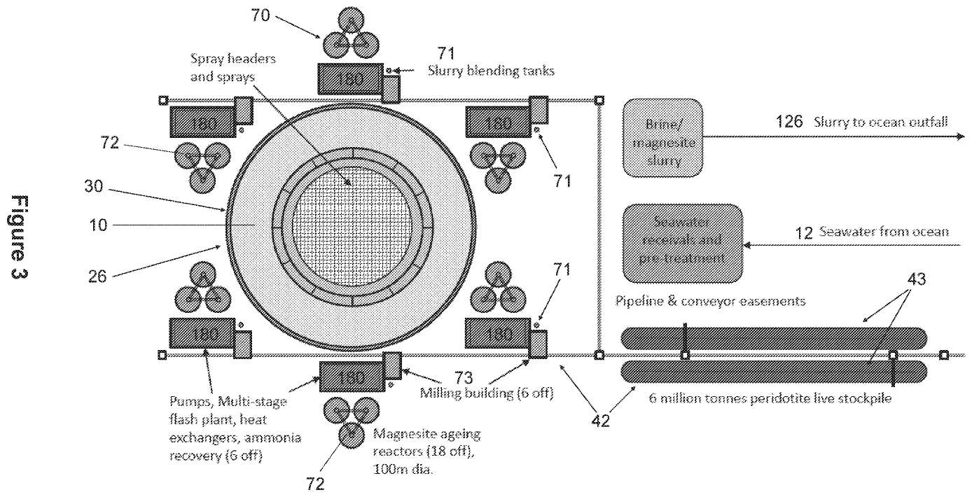

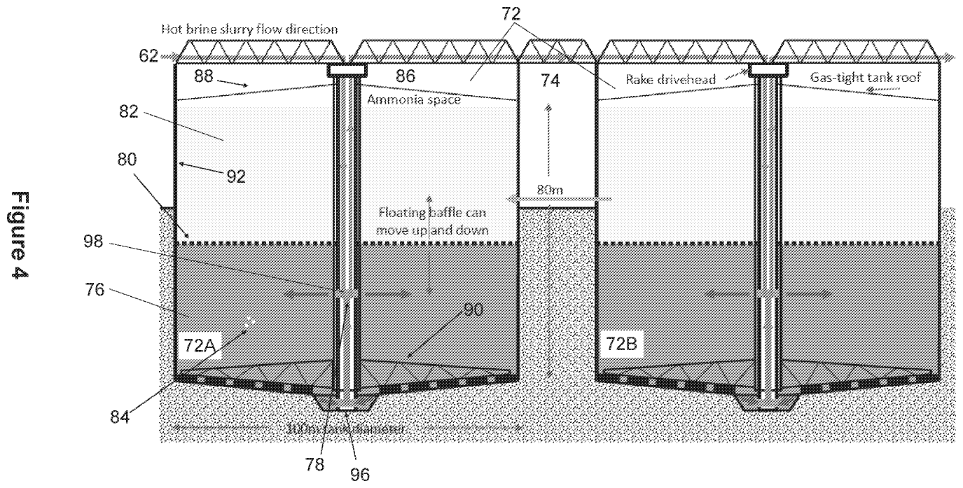

### Ammonia Recovery (FIGS. 3 and 4)

In FIGS. 3 & 4, like reference numbers to those previously employed will be used to denote similar or like parts.

A process is disclosed herein for recovering ammonia from an ammonium bicarbonate solution. Typically, the ammonium bicarbonate solution is generated by ‘scrubbing’ carbon dioxide from a gas stream using an aqueous solution comprising ammonia. The gas stream could comprise a flue gas from a power plant, a process furnace in a refinery, petrochemical or chemical plant, an incinerator, a cement kiln, etc. However, in the process disclosed herein, the gas stream comprising carbon dioxide is atmospheric air which is ‘scrubbed’ in an energy tower using an aqueous solution comprising ammonia, as set forth above. The resultant ammonium bicarbonate solution comprises an ammoniated brine that is collected in the launder 30 of the energy tower 10.

FIG. 3 is a schematic plan view of the tower 10. The ammoniated brine is collected in the launder 30 located under and surrounding the surface 26 of the tower 10. From launder 30, the ammoniated brine is pumped to slurry blending tanks 71. There are six slurry blending tanks 71 arranged around the base of the tower 10. The six slurry blending tanks 71 operate in parallel.

Peridotite 42 from live stockpiles 43 is conveyed from the stockpiles for crushing and grinding in each of six milling buildings 73, the buildings located adjacent to the six slurry blending tanks 71, respectively. The milled peridotite 42 is then added to the ammoniated brine in each of the blending tanks 71.

Each of the blending tanks 71 comprises a rotating agitator which is arranged to blend the crushed/ground peridotite 42 with the ammoniated brine, producing an ammoniated brine slurry 38. Peridotite is a magnesium silicate, primarily comprised of magnesium, silica and oxygen, but can also comprise minor amounts of iron, manganese, nickel, and other impurities including platinum group metals. Recovery of these metals from the peridotite as part of the process disclosed herein is also possible.

The reaction kinetics between the peridotite and ammoniated brine are slow at ambient conditions. To increase the rate of reaction, the ammoniated brine slurry 38 is pumped through a transfer pump 40 and heat exchanger 60 (FIG. 1) to a series of carbonation reactors 70. Each slurry blending tank 71 has a corresponding transfer pump 40 and heat exchanger 60, contained in an adjacent auxiliary equipment area 180, to pump hot pressurised ammoniated brine slurry 62 to a corresponding set of carbonation reactors 70.

The transfer pump 40 pressurises the ammoniated brine slurry 38 to a pressure of about 4.0 Bar gauge. The pressurised ammoniated brine slurry 44 is then pumped through the heat exchanger 60. In the heat exchanger 60, heat from the hot slurry 124 is recovered and used to heat the pressurised ammoniated brine slurry 44 thereby producing a hot pressurised ammoniated brine slurry 62. The hot pressurised ammoniated brine slurry 62 is now pumped to a set of carbonation reactors 70.

The six sets of carbonation reactors 70 located around the base of the energy tower 10 are operated in parallel. Each set of carbonation reactors 70 comprises three ageing and thickening reactors 72, resulting in a total of eighteen reactors 72, with each reactor having a diameter of 100 metres. The three ageing and thickening reactors 72 are configured to operate in series.

FIG. 4 shows a schematic of two such ageing and thickening reactors 72 which forma part of the set of carbonation reactors 70. The hot pressurised ammoniated brine slurry 62 is fed into the first of the three ageing and thickening reactors 72A in the set. The design and mechanics of all three reactors is identical. The description provided of the first reactor 72A is therefore applicable to all three reactors in a set.

The hot pressurised brine slurry 62 is fed into the bottom section 78 of the first reactor 72A and forms a bottom layer 76 within the reactor. The bottom slurry layer 76 is around 40 metres in depth. The bottom slurry layer 76 is overlayed with a floating baffle 80. The baffle 80 is covered by a top layer 82 of seawater.

The seawater is pumped by the pumping station 52 from the basin 50 to each reactor 72. The seawater has an average temperature of 25 °C. The top seawater layer 82 maintains a pressure on the bottom slurry layer 76. The height of the seawater layer 82 is approximately 40 metres. This depth is selected to maintain the approximately 4.0 Bar gauge pressure of the brine slurry, initially imparted by the transfer pumps 40, but then maintained by the top seawater layer 82.

The floating baffle 80 is configured such that the height of the baffle 80 within the reactor 72A is adjustable. The adjustable height baffle 80 allows the depth of the top layer 82 and the bottom layer 76 to be varied, as the baffle 80 moves up and down with decreased or increased seawater volume. By changing the depth of the top seawater layer 82, the pressure of the bottom slurry layer 76 can be controlled. For example, to increase the pressure, the seawater volume is increased whereby the baffle 80 is lowered, such that the depth of the seawater layer is increased. Every 10 metres of seawater is observed to exert approximately 1 Bar gauge of pressure on the bottom slurry layer 76.

The baffle 80 comprises around 1.5 million hollow ‘bubbles’, each equivalent to 150 mm diameter. The hollow bubbles are made from 0.25 mm aluminium sheet, each filled with fresh water and sealed, thereby forming a gas-permeable barrier. The baffle 80 has an average height of approximately 0.5 m. The baffle 80 extends across the total horizontal cross-sectional area of the reactor 72A, providing constant separation between the bottom slurry layer 76 and the top seawater layer 82. The effective specific gravity of the aluminium bubbles (being the average of water plus the metal) is approximately 1.1, which is between the specific gravity of the bottom slurry layer 76 (approximately 1.14) and the top seawater layer 82 (approximately 1.03). The baffle 80 allows gases to pass therethrough, from the bottom slurry layer 76 to the top seawater layer 82.

Under the conditions present in the first reactor 72A, the peridotite and ammonium bicarbonate react via the following reaction pathway:

4NH₃+4H₂O+4CO₂↔4NH₄⁺+4HCO₃⁻ (1)

Mg₂SiO₄+2H₂O↔2Mg⁺⁺+SiO₂+4OH⁻ (2)

4NH₄⁺+4OH↔4NH₃+4H₂O (3)

2Mg⁺⁺+4HCO₃↔2Mg(HCO₃)₂ (4)

This series of reactions 1 to 4 can be simplified to the following:

4CO₂+Mg₂SiO₄+2H₂O↔2Mg(HCO₃)₂+SiO₂ (5)

2Mg(HCO₃)₂↔2MgCO₃+2H₂O+2CO₂ (6)

with the CO₂ released reacting with ammonia as per reaction (1).

The overall reaction by which the mineral peridotite and the carbon dioxide proceed is therefore:

Mg₂SiO₄+2CO₂→2MgCO₃+SiO₂ (7)

In this way, the ammonia used to capture the carbon dioxide in the tower is reproduced for recovery via the series of reactors 70 and the carbon dioxide is sequestered as magnesium carbonate.

The overall reaction by which carbon dioxide and peridotite react (reaction (7)) is exothermic. Due to the initial heat imparted to the brine slurry in the heat exchangers 60 and the exothermic nature of the reactions, the average temperature of the bottom slurry layer is near-boiling. At a pressure of 4.0 Bar gauge, the average temperature is typically 140 °C, but can be up to 150 °C. The heat released by reaction (7) maintains these temperatures of between 140 to 150 °C within the bottom slurry layer 76 whilst the slurry is in the reactor 72. The overpressure created by the top seawater layer allows the bottom slurry layer to operate at such high temperatures, without boiling.

The actual reaction pathway is more nuanced than what is shown in reaction (6). The decomposing magnesium bicarbonate likely first forms hydrated magnesium carbonate compounds including the mineral nesquehonite (MgCO₃.3H₂O). To promote the conversion of these compounds to anhydrous magnesite, the slurry is dosed with small magnesite crystals. The magnesite crystals form as a kind of seed to encourage formation of magnesite in the slurry through Ostwald ripening.

The ammonia produced in reaction 4 initially forms bubbles 84 in the bottom slurry layer 76 due to the near-boiling temperature of the bottom slurry layer 76. The ammonia bubbles 84 rise to the top of the bottom slurry layer and pass through the gas-permeable baffle 80. As the ammonia bubbles 84 enter the top seawater layer 82, the ammonia passes into solution, thereby producing a seawater comprising ammonia. The cooler temperature of the top seawater layer 82 helps to promote the dissolution of the ammonia, ensuring that the vapour space 88 in the reactor 72A is almost devoid of ammonia vapour. As a safety-measure, the reactor 72A is fitted with a gas-tight roof 86 to reduce the likelihood of ammonia present in the vapour space 88 escaping into the atmosphere.

To assist the ammonia bubbles 84 to rise, a rake mechanism 90 at the bottom of the reactor 72A comprises air diffusers which act to mildly aerate the bottom slurry layer 76. The air diffusers produce air bubbles which pass through the bottom slurry layer 76, through the baffle 80 and finally through the top seawater layer 82. The ammonia released by the reactions tend to attach to the air bubbles as they rise, since the transfer of the ammonia to the gas phase is strongly favoured. As the air bubbles pass into the top seawater layer 82, the ammonia contained therein dissolves into the seawater, whilst the air bubbles tend to pass therethrough.

The presence of air in the bottom slurry layer 76 forms a dual purpose. Aside from promoting recovery of the ammonia to the top seawater layer 82, the presence of oxygen within the bottom slurry layer 76 maintains oxidising conditions within the slurry. This ensures that metals, such as iron, which may be present in the slurry are maintained in their more oxidised state. For example, iron is maintained as ferric.

The rake mechanism 90 also facilitates agitation of the slurry within the reactor 72A and movement of the slurry from reactor 72A to reactor 72B. The rake mechanism 90 draws settling slurry inwards towards the bottom centre of the tank 96. The settled slurry is drawn from the bottom centre of the tank 96, into the central caisson 98. From the central caisson 98, a portion of the slurry is pumped back into the bottom layer of reactor 72A, creating agitation within reactor 72A. The remaining portion of the slurry is pumped 74 into the next reactor in the series, in this case reactor 72B. From reactor 72B, the slurry is pumped into a third reactor in the series. The slurry exiting the third reactor comprises the final slurry.

As above, each of the individual ageing and thickening reactors 72 is 100 metres in diameter. Each reactor 72 has an average depth of 80 metres, with the lower ~40 metres' depth comprising the ammoniated brine slurry. This represents an effective 0.3 million cubic metres volume, equivalent to just over 24 hours' production of carbonated brine slurry 38. The internals of the reactors 72 are protected by layers of suitable saltwater-resistant coatings 92, aimed at reducing corrosion.

Within each set of carbonation reactors 70, the three individual reactors 72 operate in series, thereby providing a total of 3 days' retention time. The retention time of 3 days at elevated temperatures and pressures ensures reaction (7) proceeds essentially to completion, to in turn ensure maximal recovery of the ammonia, as well as carbon dioxide being converted to stable magnesium carbonate.

The seawater is likewise pumped between the three reactors. However, the seawater is pumped in a counter-current direction to the slurry. That is, fresh seawater is added to the third reactor. The seawater from the third reactor is then pumped to reactor 72B. Finally, the seawater from reactor 72B is pumped to reactor 72A. The concentration of ammonia in the seawater progressively increases as the seawater is pumped between the tanks. The seawater exiting reactor 72A becomes the seawater comprising ammonia stream 102, which is ready to be reused in the tower.

To this end, the seawater comprising ammonia 102 (FIG. 1) that exits reactor 72A is pumped via the pumping station 52 up to the upper end of the tower 10. The ammonia in the seawater stream 102 is thereby recycled for reuse in scrubbing the gas stream comprising carbon dioxide. This allows the carbon capture tower to operate in a “closed-loop” system with respect to ammonia, because the ammonia used to capture the carbon dioxide is regenerated by the process. Typically, small amounts of ammonia are required to make-up for unavoidable losses of ammonia that will occur over time.

The final slurry exiting the third reactor in each series of carbonation reactors 70, is a hot slurry 71 comprised primarily of magnesium carbonate and silica. The hot slurry also comprises a small amount of residual ammonia. The residual ammonia is recovered by passing the hot slurry 71 through a multistage flash distillation stage 120. Each series of carbonation reactors 70 has a corresponding multistage flash distillation plant, housed within the corresponding auxiliary equipment facility 180.

In the multistage distillation stage 120, the remaining ammonia is distilled off from the slurry. This is achieved using a number of flash evaporators arranged in series, wherein each evaporator in the series has a pressure lower than the preceding evaporator. The increasingly lower pressures cause the hot slurry to boil within each evaporator. As the hot slurry boils, producing water vapour, the water vapour strips ammonia from the hot slurry, according to the equilibrium liquid/vapour concentrations at each set pressure. A mixed water-ammonia vapour 126 is thereby produced.

Typically, the water-ammonia vapour 126 is cooled and condensed by directly contacting the vapour with the seawater comprising ammonia 102 that exits reactor 72A at mixing point 125, thereby producing the total solution comprising ammonia 128 which is reused in the tower 10 for carbon dioxide capture.

Optionally, the mixed ammonia-water solution 126 is passed to an ammonia-water separation stage 150. In this stage 150, the mixed ammonia-water solution 126 is fractionated to yield additional fresh water 154 and a more concentrated ammonia-water solution 156. The more concentrated solution 156 is combined with the seawater comprising ammonia 102 to form the combined solution comprising ammonia 128.

The hot magnesium carbonate and silica slurry 124 exiting the multistage flash distillation is now depleted of ammonia, but still contains significant quantities of recoverable heat energy. To recover heat energy from the hot slurry 124, the hot slurry 124 is passed through the heat exchanger 60, where it is used to heat incoming pressurised ammoniated brine 44 passing therethrough.

There are three options for the cooled ammonia-depleted slurry. First, the cooled ammonia-depleted slurry 129 is disposed of directly (and safely) to the ocean (for example to counter effects of ocean acidification).

Second, the cooled ammonia-depleted slurry is passed to a solids-liquids separation stage 130. In this stage, thickeners are used to produce a carbonated mineral paste 132 as an underflow. The carbonated mineral paste 132 is essentially inert, rendering it suitable for use as landfill (e.g. at the mine site from which the metal silicate was mined), for emplacement in playas on land, or for direct disposal into the ocean. The overflow from the thickener is a cooled brine 134 which can be discharged back to the ocean.

Third, the cooled ammonia-depleted slurry is passed to a magnesium carbonate—silica separation stage 140. In stage 140, the slurry undergoes flotation wherein a silica product 142 is floated to the top and a magnesium carbonate product 144 is collected as an underflow. The products (142 and 144) can be used by the construction industry and/or for construction activities associated with the energy tower 10. The silica product 142 may optionally be melted in an electric furnace and spun using familiar glass-fibre production equipment. The resultant silica fibres can (e.g. be chopped and) be used as a reinforcing in a magnesium carbonate cement.

Any of the first, second, or third options can also comprise a process for recovering valuable metals present in peridotite. The recovery of these valuable metals is achieved using familiar chemical processes. In this way, the process can also obviate alternative mining for valuable metals, which frequently involves broadly negative environmental practices. The recovery of metals such as nickel, cobalt, iron, base and precious metals, also increases the revenues associated with operating the system.

A novel use for the carbonated mineral paste 132 produced from solids-liquids separation 130 is as an inert construction material, which can be used to construct further energy towers. A foamed cement can be made from a blend of magnesium oxide, the carbonated mineral paste 132 and carbonated water (essentially soda water with suitable foaming agents added) in the proportions 1:4:2. These are mixed to form a dense paste. Sufficient carbon dioxide is injected under pressure at the point of emplacement to achieve, upon expansion, a foam cement with a fully cured density of around 1,000 kg/m³. That is, 60% of the volume of the ‘concrete’ would be gaseous carbon dioxide.

Reinforcement for the tower can be provided in the form of spun silica-such as may be obtained from the silica 142 separated in the magnesium carbonate-silica separation stage 140. Magnesium oxide can be produced by calcining a portion of the magnesium carbonate 144 recovered in stage 140 to produce a mixture of magnesium carbonate, hydroxide and oxide, for use in the cement.

As the foamed concrete is set, hydration of magnesium oxide to magnesium hydroxide occurs, removing most of the free moisture from the paste. Then, the carbon dioxide in the bubbles reacts to convert some of the hydroxide to carbonate, thereby forming hydromagnesite (Mg₅(CO₃)₄(OH)₂.4H₂O). Over time, the pressure in the bubbles will decrease as the carbon dioxide is consumed in the formation of these compounds. The decreasing pressure in the bubbles creates a compressive force, further strengthening the foamed concrete.

The foamed concrete may be used to construct a large tower, such as the elongate tower 10 shown in FIG. 2. The tower 10 is shaped using sliding formwork. The foamed concrete is delivered and placed using high-pressure paste pumps and pressurised carbon dioxide.

For a tower 1,200 m tall with an average wall thickness of 12 m and an average diameter of 450 m (consistent with a minimum diameter of 400 m, flared both above and below this midsection), the total volume of the shell wall would be of the order of 17 million cubic metres. Allowing for an additional 3 million cubic metres to be deployed in construction of the distributors, mist eliminators and other facilities, the total mass of aerated concrete required is 20 million tonnes.

Each of these large towers can be operated to capture carbon dioxide using the process as described herein. Each tower has the capacity to produce approximately 80 million tonnes annually of magnesium carbonate, plus a further 60 million tonnes per year of other solids, mostly silica. It is therefore evident that the magnesium carbonate and silica produced by one of these large towers is sufficient for the construction of subsequent towers.

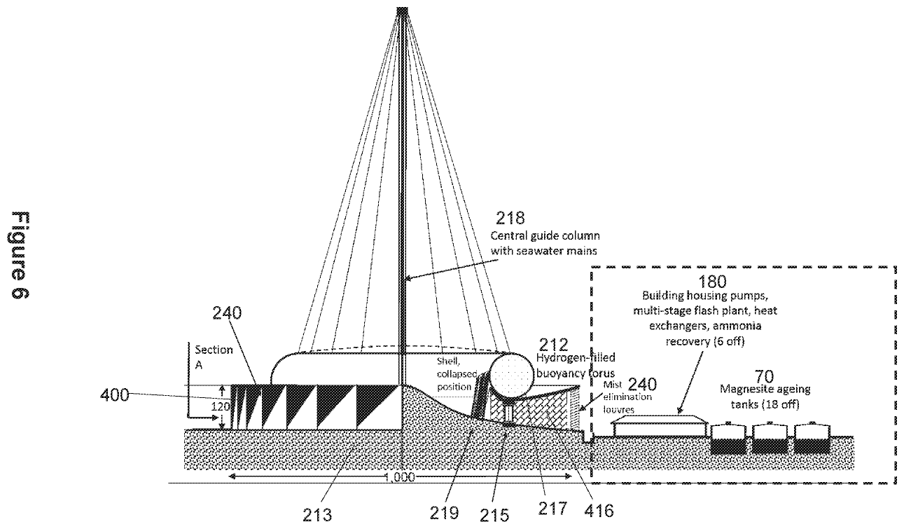

### Deployable Tower (FIGS. 5 and 6)

In FIGS. 5 & 6, like reference numbers to those previously employed will be used to denote similar or like parts. As set forth above, an elongate hollow tower used for capturing carbon dioxide from the atmosphere is typically a massive structure. The towers are also preferably located in coastal desert regions where the air is hot and dry. Such locations optimise the high downdraft velocities produced by the reverse-chimney effect, created as an aqueous solution is distributed into the hot, dry air located at/in the upper end of the tower. As the kinetic energy of the downdraft is converted to electrical energy, higher downdraft velocities enable the generation of larger amounts of electricity.

However, many of the coastal desert regions identified as suitable locations for such a tower are also prone to tropical cyclones, possibly reaching Category 5 strengths—for example the Pilbara, Arabian Sea, and southern Baja California.

Extremely tall structures involving heavy materials operating under compression tend to be far more massive than structures involving tension alone. Herein is presented a deployable structure 200 in which a resulting tower operates under tension. The structure has an in-use position and an off position, such that the structure may reside in the off position during a tropical cyclone or for maintenance.

FIG. 5 shows a schematic of the deployable structure from a front elevation when the tower is in the in-use (erected/deployed) position. FIG. 6 shows a schematic of the same structure from the same front elevation, but when the tower is in the off (collapsed/non-deployed) position.

The deployable structure 200 has a collapsible wall 208 that is deployable between a collapsed orientation (shown in FIG. 6) and an erected orientation (shown in FIG. 5). When the collapsible wall 208 is in the erected orientation, the collapsible wall defines an elongate hollow enclosure 209. When so erected, an upper end 202 of the collapsible wall 208 forms the upper end of the structure 200, and a lower end 204 of the collapsible wall 208 forms the lower end of the structure 200. Further, the upper end 202 of the structure 200 is open to the atmosphere, thereby allowing a gas stream (i.e. atmospheric air) to pass into the open upper end 202 of the structure. The collapsible wall 208 comprises a very strong yet flexible material (e.g. a multi-layered, woven, fibre-reinforced tough polymer or canvass), thereby allowing the collapsible wall 208 to be deployed between the collapsed and erected orientations.

When erected, the collapsible wall 208 assumes a generally hyperbolic configuration when viewed in a front elevation (FIG. 5). The smallest diameter of 400 m of the collapsible wall 208 occurs at an intermediate location 210 of the collapsible wall 208. The upper end 202 and lower end 204 of the collapsible wall are flared above and below the intermediate location 210. Therefore, the top and bottom sections of the erected collapsible wall 208 each has a diameter larger than 400 m. Further, the lower end 204 of the wall 208 is secured around its perimeter to a main structure 211 that upstands from a base 213 of the energy tower. The base 213 of the energy tower is of high strength, reinforced concrete and is bell-shaped in cross-section up to a central region thereof. The main structure 211 is also typically formed from reinforced concrete.

The main structure 211 also comprises one or more turbines 215 mounted to and supported therein. As described in more detail below, the turbines 215 are configured to generate electricity as a result of the high volumetric flow of a CO₂-depleted airstream therethrough.

To facilitate its movement from the collapsed to the erected configuration, the deployable structure 200 also comprises a balloon structure in the form of a toroidal balloon 212. The toroidal balloon 212 is connected to the upper end 202 of the erected collapsible wall 208. As the toroidal balloon 212 is deployed from a grounded position to an elevated position, it causes the collapsible wall 208 to move (expand) from the collapsed orientation (FIG. 6) to the erected orientation (FIG. 5).

The main structure 211 is also shaped to define a recess 217 in which the toroidal balloon 212 sits when in the grounded position (FIG. 6). In the grounded position, suitable fixtures on the toroidal balloon 212 are respectively secured to suitable fittings on the main structure 211 to tie/hold the toroidal balloon 212 in the grounded position. Further, in this position, the wall 208 assumes a concertinaed collapsed orientation 219.

The toroidal balloon 212 is filled with a gas or gases less dense than air (typically comprising hydrogen or helium) and is fully sealed. The over-pressure of the gas within the toroidal balloon 212 does not exceed 20 kPa—i.e. 20% above normal atmospheric pressure at sea level. Such an over-pressure is selected to accommodate ambient temperature extremes, which can span 50 °C in the aforementioned regions.

When the toroidal balloon 212 is released (i.e. unlocked from its couplings to main structure 211) it rises and causes the collapsible wall 208 to move from the collapsed to the erected position, with the toroidal balloon 212 thereby providing a buoyancy force. Effectively, the toroidal balloon 212 suspends the collapsible wall 208 from above. In this way, the structure 200 operates in use under tension, which provides a certain stability to the structure.

The toroidal balloon 212 has a circular cross-section and is circular around its periphery, effectively forming a large toroidal (doughnut-shaped) structure. Typically, the toroid has a major (external) radius 214 of 320 metres and a minor (balloon internal) radius 216 of 60 metres, resulting in an internal volume of approximately 21 million cubic metres. At sea level, this equates to a buoyancy force of approximately 24,000 tonnes when the toroidal balloon 212 is filled with hydrogen, and a buoyancy force of approximately 21,000 tonnes when the toroidal balloon 212 is filled with helium.

There are design challenges associated with the use of hydrogen as it is highly flammable and leak-prone. However, hydrogen presents a better option due to the lower cost and larger buoyancy force provided. Hydrogen is thus preferred over helium.

The total surface area of the toroidal balloon 212 and the collapsible wall 208 amount to approximately 2.3 million square metres. If made from a multi-layered, reinforced fabric of 5.0 mm average thickness and a specific gravity of 2.0, their combined weight is approximately 24,000 tonnes. Therefore, the buoyancy force provided by the toroid filled with hydrogen toroidal balloon 212 is sufficient to support the weight of the toroidal balloon 212 itself plus the collapsible wall 208, when the structure is in the in-use (erected) position shown in FIG. 5.

To help guide the toroidal balloon 212 between the grounded position and the elevated position, the deployable structure contains a guide structure. The guide structure comprises a hollow guide column 218 which is centrally located within the toroidal balloon 212 and the collapsible wall 208, with the column embedded deeply within and extending vertically up from a centre 222 of the bell-shape of the tower base 213.

The guide structure further comprises a plurality of guide wires 220. The guide column 218 is connected to the toroidal balloon 212 via the plurality of guide wires 220. A first end 221 of each of the plurality of guide wires 220 is connected to the toroidal balloon 212. In this regard, each of the first ends 221 are connected at discrete, spaced points around a periphery of the toroidal balloon 212. The connection points for each guide wire first end 221 typically comprise a reinforced, robust, secure formation affixed to or incorporated into a wall of the toroidal balloon 212.

The plurality of guide wires 220 extend through the guide column 218 to a remote second end located within the tower base 213, where the second end of each wire is connected to a respective drive spool. Each drive spool is electrically motor-driven to allow its respective guide wire to be reeled out or in as the balloon structure 212 moves between the grounded and elevated positions.

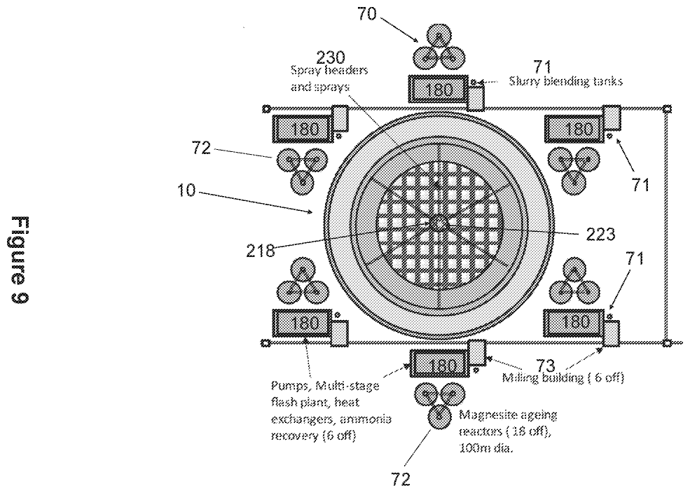

As shown in more detail in FIG. 9, the guide column 218 further comprises fluid-delivery pipes 223 arranged within the hollow of the column and extending from within the tower base 213. Each pipe is nominally 2.5 metres internal diameter. These pipes connect to the pumps in the pumping stations 52 to allow an aqueous solution, optionally comprising a reagent, e.g. seawater comprising ammonia 102, to be pumped to the top of the column 218.

As also shown in FIG. 9, a distributor in the form of spray headers and sprayers 230 is connected to the upper end of the pipes 223 and to the upper end of the column 218. The spray headers and sprayers 230 are arranged to charge the seawater comprising ammonia into the open upper end of the structure 200. The seawater comprising ammonia is spayed (e.g. fine droplets/mist/atomised) such that it mixes with the atmospheric air to cool the same by evaporative cooling. As a result of such evaporative cooling, the density of the mixture increases and passes downwards as a stream 226 through the deployable structure 200, causing a downdraft. As the stream passes down, ammonia in the seawater continues to react with carbon dioxide in the atmospheric air, forming ammonium bicarbonate in solution.

Other inclusions in the guide column 218 include a substantial elevator to allow transport of maintenance and other personnel along with repair, monitoring and other equipment to and from the top of the tower, and guideways and pulleys for the cables supporting the spray headers.

Since the buoyancy force provided by the toroidal balloon 212 is sufficient to support the weight of the toroidal balloon 212 itself plus the collapsible wall 208, the guide column 218 need only support the weight of the guide column 218 itself plus the spray headers and sprayers 230, pipes 223, and portions of guide wires 220 within the column.

A separator is defined by the convex surface 26 of the tower base 213. As the downwards stream 226 engages with the surface 26, the ammonium bicarbonate solution condenses thereat and is separated from the carbon dioxide depleted air. The ammonium bicarbonate solution flows down the surface 26 and is collected in the peripheral collection launder 30 located in the tower base 213. The flow down along surface 26 to launder 30 can be promoted by flow channels formed therein.

The structure again comprises additional apparatus 180 arranged for recovering ammonia from the ammonium bicarbonate solution collected in the collection launder 30, and apparatus 70 for producing magnesite and silica. The apparatus 180 also regenerates the seawater comprising ammonia solution 102 according to the process previously described.

The vast amount of kinetic energy of the CO₂-depleted air is harnessed and converted to electrical energy. As described in more detail below, this is achieved through a combination of one or more turbines 215 located in the main structure 211 and supported at the base 213 of the tower. Also, as described in more detail below, the energy tower is configured to generate an electric field in the airflow passing down through the tower.

Mist eliminators 240 are located at the exit of the turbine(s) to capture remaining airborne solution from the exhaust and direct it into the brine collection launder 30.

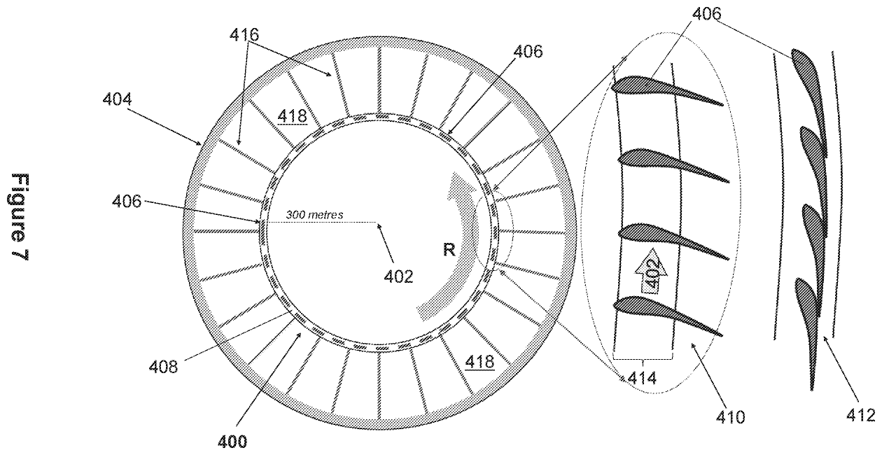

### Single (Large) Turbine (FIG. 7)

Instead of a series of discrete, spaced turbines located around at the airstream exit of the energy tower, a single large turbine 400 can be located in the main structure 211 at the base 213 of the structure of FIGS. 5 and 6. The single large turbine 400 enables the conversion of kinetic energy from the airstream downdraft 226 to electrical energy.

FIG. 7 shows a plan schematic of the turbine 400. The turbine 400 is installed within a circular concrete footing 404 located within the base 213 of the structure. The turbine 400 has a radius of 300 metres. Between the turbine 400 and the circular concrete structure 404 are a series of walls 416 that form compartments 418. The compartments, each effectively a divergent nozzle, serve to slow down (decelerate) the humidified air after it has passed through the blades of the turbine 400, in turn recovering more of the kinetic energy of the downdraft airstream and raising the net electricity generated by the turbine. Slowing the air-flow in this way (perhaps to one-third the space velocity of the air through the turbine 400) also facilitates the separation of brine droplets from the now-slowed air stream in the mist elimination louvres 240.

The rotational axis 402 of the turbine 400 is aligned with the elongate axis of the deployable structure 200 and column 218. Although the turbine 400 is herein described with reference to the deployable structure 200, it is to be understood that the turbine 400 can be installed and used in various (e.g. rigid concrete, etc.) elongate hollow towers.

After contacting the separator surface 26, the CO₂-depleted air flows laterally out to the turbine 400. The turbine 400 comprises a series of equally spaced turbine blades 406 arranged on a rotor 408 that rotates on the turbine rotational axis 402. The flow of air acts on the turbine blades 406, causing the rotor 408 to rotate in the direction of arrow R. The turbine blades 406 have a sail profile, allowing the flow of air to act on and impart movement to the turbine blades 406 translating through to the rotor 408. Each turbine blade 406 is 60 metres tall and 15 metres wide.

The turbine blades 406 have an adjustable pitch, allowing the orientation of the turbine blades 406 to be adjusted depending on current wind conditions, and allowing optimisation of electricity generation. Typically, the blade pitch is initially set to 15°. The number of turbine blades 406 can also be adjusted, depending on wind conditions. Up to say ~200 such turbine blades 406 can be installed on the rotor 408.

The turbine blades 406 are adjustable between an operating position 410 and a closed position 412. In the operating position 410, the flow of air is able to cause the turbine blades 406 to impart movement to the rotor 408. In the closed position 412, the turbine blades 406 are closed to the flow of the air. This allows the turbine 400 to be switched off, for example, if maintenance on the turbine is required or if the deployable structure is in an off (e.g. collapsed) position.

The rotor 408 comprises an upper runner 414 and a lower runner, with the lower runner located and spaced directly beneath the upper runner 414 shown in FIG. 7. The in-use upper end of each of the turbine blades 406 is attached to the upper runner 414. The in-use lower end of each of the turbine blades 406 is attached to the lower runner. There are also large permanent magnets affixed along the upper runner 414 and the lower runner. Preferably, these permanent magnets are arranged in Halbach Arrays, which contrive to double the magnetic force on an upper (or strong) face and essentially eliminate it on the opposite (lower, or weak) face.

The turbine 400 also comprises a stator with a top frame and a bottom frame (not shown in FIG. 7 but see FIGS. 5 & 6). The stator top frame is mounted within the main structure 211 and the stator bottom frame is mounted within the base 213. The upper runner 414 of the rotor 408 is received by the top frame of the stator. The bottom runner of the rotor 408 is received by the bottom frame of the stator. Both the top frame and bottom frame of the stator contain electrical windings.

As the flow of air acts on the turbine blades 406 causing the rotor 408 to rotate, the stator remains stationary within the main structure 211 and base 213. The movement of the permanent magnets (Halbach arrays) affixed to the runners of the rotor 408 across the electrical windings affixed to the stator, causes an electric current to be induced in the electrical windings. Hence the kinetic energy of the flow of air is converted to electrical energy.

Any friction between the rotor 408 and the stator results in the conversion of kinetic energy to heat energy, and therefore represents an energy loss. To minimise this energy loss, friction between the lower runner and the bottom frame is minimised by magnetically levitating the lower runner above the bottom frame. Magnetic levitation is achieved through the use of precisely controlled electromagnets. This results in an air gap between the lower runner and the bottom frame, allowing friction-free passage of the lower runner along the bottom frame. Likewise, friction between the upper runner and the top frame is minimised by magnetic repulsion. Magnetic repulsion is achieved through the use of precisely controlled electromagnets, thereby producing an air gap between the upper runner and the top frame. The presence of the air gap allows friction-free passage of the upper runner along the top frame.

In both runners, Halbach arrays readily facilitate friction-free levitation so long as the rotor 408 is in motion. When stationary, magnetic levitation is not obtained, so a second mechanism to levitate the rotor sufficiently for the rotor to clear the lower stationary stator needs to be employed. Such a mechanism may be in the form of injection of compressed air to create such an air gap, or a series of auxiliary wheels. In many ways, the mechanism is derived from work into a magnetic levitation transport system (Inductrack) developed in the USA at the Lawrence Livermore Laboratories with private sector partners including General Atomics, but in this case the turbine 400 operates as a linear induction generator rather than motor. See for example ‘The Inductrack: a simpler approach to magnetic levitation’ |IEEE Journals & Magazine |IEEE Xplore.

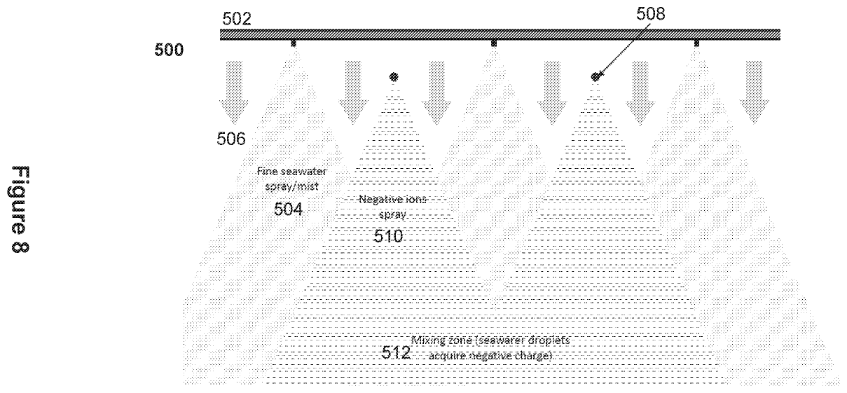

### Static Electricity Generation (FIG. 8)

In combination with, or instead of, generating electricity using a turbine, electricity can be generated from the downwards stream by imparting a charge on the aqueous component of the downwards stream. Such a system has a particular advantage over the turbine system described above in that it does not contain any moving parts.

The system is based on the concept of the electrostatic wind energy converter (EWICON) developed by Delft University in Rotterdam (a complete description of the research can be found here http://resolver.tudelft.nl/uuid:81221f03-9d46-4c7c-a560-b859a26f7d04, the relevant contents of which are incorporated herein by way of cross-reference).

FIG. 8 provides a schematic of a section of the total system 500. The section depicted in FIG. 8 is installed at the upper end of a suitable elongate hollow tower, such as the in-use deployable structure 200 described above (e.g. connected to the guide column 218). A distributor 502 charges an aqueous solution, such as seawater, into the upper end of the deployable structure. The seawater is charged in the form of droplets, thereby forming a fine seawater mist 504.

The distributor 502 charges the seawater such that, as the fine seawater mist 504 mixes with a gas, for example atmospheric air, the droplets 504 evaporatively cool the gas. As a result of such evaporative cooling, a downward draft 506 (i.e. gas stream) is produced which causes the mixture to pass downwards as a stream through the tower.

The upper end of the deployable structure also contains an electrical charging apparatus 508. The electrical charging apparatus 508 is placed just below the distributor 502. The electrical charging apparatus 508 comprises a grid of electrically conductive parts. More particularly, the grid comprises conductive rods, wires, sharp edges and points.

The electrical charging apparatus 508 is configured to convert an imposed voltage into a spray of negatively charged ions 510. This is achieved through a coronal discharge from each of the electrically conductive parts. The negatively charged ions 510 are directed downwards into the tower. When the distributor is spraying droplets 504, the negative ions 510 mix with the droplets 504 in a mixing zone 512. Initially, the droplets 504 are electrically neutral. In the mixing zone 512, the droplets 504 acquire a negative charge due to the interaction between the droplets 504 and the negative ions 510. The negatively charged droplets then flow down in the deployable structure due to the downward draft 506.

The upper end of the deployable structure 200, comprising the balloon structure 212 and the distributor, are electrically isolated from the rest of the deployable structure. The electrical charging apparatus 508 is electrically isolated from earth. The net result is that, as the negatively charged droplets are forced down the deployable structure 200 by the downward draft 506 and away from the electrical charging apparatus 508, there is a rise in the electric potential of the electrical charging apparatus 508. The electrical charging apparatus 508 gains a positive polarity. There is therefore an attractive force between the electrical charging apparatus 508, now with a positive polarity, and the negatively charged spray droplets. As the negatively charged spray droplets are forced down the deployable structure by the downward draft 506, work is done on the spray droplets. A portion of the kinetic energy possessed by the droplets and downward draft 506 is converted into electrical energy.

To optimise the generation of electrical energy, both the inner surface of the collapsible wall 208 and the central guide column 218 are coated with an effective water repellent to encourage ‘beading’of water droplets that reach its surface. Additionally, the central guide column 218 is electrically insulated, and the electrical charging apparatus 508 is arranged with respect to the distributor 502 such that the droplets are charged only after their formation.

A series of earth conductors are arranged at the lower end of the deployable structure (e.g. at the tower base 213). The earth conductors are arranged to collect the charged droplets being forced through the tower. As the charged droplets contact the earth conductors, charge is transferred from the charged droplets to the earth conductors, thereby producing a charge-neutral aqueous solution and a charge which can be harnessed as an electrical current.

The electrical current is directed through a load, before flowing back to the electrical charging apparatus. The load typically comprises the pumping system which pumps the aqueous solution to the upper end of the guide columns. The load can also comprise other electrical components present as part of the deployable structure. Depending on the amount of electrical energy generated, some of the current can be used to partially power nearby towns, infrastructure, etc.

This solution may not yield as high electrical generation efficiencies as, for example, the turbine system previously disclosed. However, energy not converted to electricity remains as kinetic energy-that is, the velocity of the downdraft. This will in turn lead to greater air fluxes through the deployable structure. Ideally, both this system and the turbine are incorporated into the deployable structure.

### Further Variations

Variations and modifications may be made to the process as previously described without departing from the spirit or ambit of the disclosure.

In the claims which follow, and in the preceding description, except where the context requires otherwise due to express language or necessary implication, the word “comprise” and variations such as “comprises” or “comprising” are used in an inclusive sense, i.e. to specify the presence of the stated features but not to preclude the presence or addition of further features.

1. A process for recovering ammonia from a solution comprising ammonium bicarbonate, such as a solution produced by scrubbing a gas stream with an aqueous solution comprising ammonia to remove carbon dioxide from the gas stream, the process comprising:
mixing the solution comprising ammonium bicarbonate with a metal silicate to form an ammoniated slurry;
subjecting the ammoniated slurry to reaction conditions by which the ammonium bicarbonate reacts with the metal silicate to form a metal carbonate and silica slurry, and whereby ammonia is released, the ammoniated slurry being overlayed with an aqueous layer to create a top aqueous layer and a bottom ammoniated slurry layer, whereby the ammonia that is released from the bottom ammoniated slurry layer is able to pass into the top aqueous layer to thereby produce an aqueous solution comprising ammonia.

2. The process according to claim 1, wherein the reaction conditions comprise elevated temperatures and/or elevated pressures, and wherein the elevated temperature is below the boiling point of water at the elevated pressure.

3. (canceled)

4. The process according to claim 2, wherein the elevated pressure of the ammoniated slurry is generated by overlaying the ammoniated slurry with the top aqueous layer.

5. The process according to claim 4, wherein the depth of the top aqueous layer is varied to control the elevated pressure of the ammoniated slurry.

6. The process according to claim 1, wherein during the reaction between the ammonium bicarbonate and the metal silicate, the top aqueous layer is maintained separated from the bottom ammoniated slurry layer, whereby the aqueous solution remains separated but ammonia is able to pass from the bottom ammoniated slurry layer into the top aqueous layer.

7. (canceled)

8. The process according to claim 1, wherein, the reaction conditions, comprise one or more of:
subjecting the ammoniated slurry to agitation;
subjecting the ammoniated slurry to aeration, such as by injecting air bubbles into the ammoniated slurry; or
passing the ammoniated slurry through a series of reactors, whereby the aqueous solution is flowed in a counter-current direction to the ammoniated slurry.

9. (canceled)

10. (canceled)

11. (canceled)

12. The process according to claim 1, wherein the aqueous solution comprises seawater.

13. The process according to claim, wherein the ammoniated slurry is subjected to an elevated temperature of about 150 °C and an elevated pressure of about 4.0 Bar gauge.

14. (canceled)

15. The process according to claim 1, wherein the reaction of the ammonium bicarbonate with the metal silicate, and the production of the aqueous solution comprising ammonia, is conducted in one or more sealed reactors to thereby prevent ammonia from escaping into the atmosphere.

16. The process according to claim 1, wherein the aqueous solution comprising ammonia is recycled for reuse in scrubbing the gas stream comprising carbon dioxide.

17. (canceled)

18. (canceled)

19. The process according to claim 1, wherein the metal silicate comprises an ultramafic mineral such that the reaction between the ammonium bicarbonate and the metal silicate produces magnesium carbonate and silica.

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. A deployable structure, such as can be used for scrubbing a gas stream, the deployable structure comprising:
a collapsible wall wherein the collapsible wall is deployable between a collapsed orientation and an erected orientation;
a balloon structure, filled with a gas or mixture of gases less dense than air, wherein the balloon structure is connectable with respect to the collapsible wall and is configured to cause the collapsible wall to move from the collapsed orientation to the erected orientation as the balloon structure is deployed from a grounded position to an elevated position;
a guide structure configured to guide the balloon structure as it moves from the grounded position to the elevated position and causes the collapsible wall to move from the collapsed orientation to the erected orientation; and
a distributor located at a top of the guide structure and configured to charge into the deploy able structure an aqueous solution, such that the aqueous solution mixes with the gas stream within the deployable structure to evaporatively cool the gas stream, thereby creating a downward draft and causing the aqueous solution to pass as a downwards stream through the deploy able structure.

33. The deploy able structure according to claim 32, wherein the collapsible wall is configured such that, when in the erected orientation, the collapsible wall divides an internal space of the structure from an external space to define an elongate hollow enclosure, and whereby the gas stream is able to pass into an open upper end of the elongate hollow enclosure.

34. (canceled)

35. (canceled)

36. The deployable structure as according to claim 32, wherein the balloon structure has a circular cross-section and is circular around its periphery, and wherein the balloon structure is connected to an in-use upper edge of the collapsible wall around the periphery of the balloon structure.

37. (canceled)

38. The deployable structure according to claim 32, wherein the guide structure comprises a guide column connected to the balloon structure, and wherein the guide column is connected to the balloon structure through a plurality of guide wires, wherein a first end of each of the plurality of guide wires is connected to the balloon structure, with each of the plurality of guide wires extending through the guide column to a second remote end thereof.

39. (canceled)

40. (canceled)

41. (canceled)

42. (canceled)

43. The deployable structure according to claim 32, wherein:
the deploy able structure further comprises one or more pipes located at the guide structure and connected to the distributor through which pipes the aqueous solution can be pumped to the top of the guide structure;
the guide structure is centrally located within the deployable structure in use, and wherein the distributor comprises a series of spray headers which have a first end connected to the guide structure and a second end connected to the balloon structure; and
the series of spray headers are configured with the guide structure and the balloon structure such as to allow the spray headers to be deployed between a non-use position and an in-use position as the balloon structure is moved between the grounded position and the elevated position.

44. (canceled)

45. (canceled)

46. The deploy able structure as claimed in according to claim 43, further comprising electricity generation apparatus that is configured to generate electricity from the downwards passing stream.

47. (canceled)

48. (canceled)

49. A system for electrical energy generation in an elongate hollow tower, the elongate hollow tower having an elongate axis, the tower configured such that atmospheric air is able to pass downwards through the tower from an upper end towards a lower end, the system comprising:
a distributor arranged to charge into the tower an aqueous solution which mixes with the atmospheric air to evaporatively cool the air, thereby creating a downward draft and causing the mixture to pass as a downwards stream through the tower;
a turbine which is configured such that its rotational axis is able to be aligned with the elongate axis of the tower, the turbine comprising a series of turbine blades that are arranged on a rotor that rotates on the turbine rotational axis, the turbine being further arranged in use such that the downwards stream passes through the turbine, acting on the turbine blades, thereby causing the rotor to rotate and generate electrical energy.

50. (canceled)

51. The system according to claim 49, further comprising a separator arranged at a lower end of the tower to separate the aqueous solution from the downwards stream, thereby producing an airstream which flows to the turbine.

52. The system according to claim 49, wherein the turbine blades have a sail profile such that, as the downwards stream flows onto a face of the blade, the blade causes the rotor to rotate, and wherein the turbine blades are adjustable between an open position in which the downwards stream is able to cause the blade to act on the rotor, and a closed position in which the turbine is closed to a flow of the downwards stream therethrough.

53. (canceled)

54. The system according to claim 49, wherein the rotor further comprises:
an upper runner to which an in-use upper end of each of the turbine blades is attached and a lower runner to which an in-use lower end of each of the turbine blades is attached, with permanent magnets being affixed to both the upper runner and the lower runner; and
a stator with a top frame in which the upper runner is received, and a bottom frame in which the lower runner is received, with electrical windings being affixed to the stator such that, as the downwards stream acts on the turbine blades to cause the rotor to rotate whilst the stator remains stationary, the moving permanent magnets induce an electric current in the electrical windings.

55. (canceled)

56. (canceled)

57. (canceled)

58. (canceled)

59. (canceled)

60. (canceled)

61. (canceled)

62. A system for power generation using an electric field in an elongate hollow tower, such as may be used for sequestering carbon dioxide from a gas stream, the elongate hollow tower being configured such that the gas stream is able to pass downwards through the tower from an upper end towards a lower end, the system comprising:
a distributor arranged to charge into the tower an aqueous solution wherein the distributor charges the aqueous solution in the form of droplets, such that the droplets mix with the gas stream to evaporatively cool the gas stream, thereby creating a downward draft and causing the mixture to pass as a downwards stream through the tower;
electrical charging apparatus arranged at the upper end of the tower but positioned below the distributor, the apparatus being configured to provide an electrical charge to the droplets, thereby producing charged droplets that pass downwards through the tower due to the downward draft, and wherein the electrical charging apparatus is electrically isolated from earth;
a series of earth conductors arranged at the lower end of the tower, wherein the charged droplets passing downwards through the tower are collected and charge is transferred from the droplets to the earth conductors, thereby producing a charge-neutral aqueous solution, with the collected charge flowing back to the electrical charging apparatus.

63. (canceled)

64. (canceled)

65. (canceled)

66. (canceled)

67. (canceled)

68. (canceled)

69. (canceled)
